(19) United States
(12) Patent Application Publication
(10) Pub. No.: US 2012/0330619 A1
(43) Pub. Date: Dec. 27, 2012

(54) DYNAMIC CONNECTION VISUALIZATION IN COMPUTER AIDED DESIGN PACKAGE

(75) Inventors: Rubina F. Ahmed, Austin, TX (US); Antrell K. Grice, Durham, NC (US); Sunil K. Mishra, Morrisville, NC (US); Adam J. Parker, Cary, NC (US)

(73) Assignee: International Business Machines Corporation, Armonk, NY (US)

(21) Appl. No.: 13/164,943

(22) Filed: Jun. 21, 2011

(51) Int. Cl. G06F 17/50

(52) U.S. Cl. 703/1

(57) ABSTRACT

In a disclosed example, nets are used to represent connections between elements on different pages of an electronic drawing in a software package for computer aided drawings. Previews for these connections are automatically generated, such as during an automated inventory of the electronic drawing. The automatically-generated connection previews are stored in memory, such as in a preview database, for subsequent recall and display. The user may select a net to recall and display the previously generated connection preview. The user may then select the displayed preview to be added to a dynamic workspace, such as by clicking on the connection preview using a pointing device. Elements and connections added to the dynamic workspace are fully editable from the dynamic workspace. Any changes made in the dynamic workspace are updated to the pages containing the changed elements.

### BACKGROUND

1. Field of the Invention

The present invention relates to computer-aided design, and more particularly to systems and methods for facilitating the display of an electronic drawing that spans multiple pages.

2. Background of the Related Art

Computer Aided Design (CAD) is a software-driven drawing tool for creating and modifying drawings using a computer. CAD is commonly used to prepare electronic technical drawings for buildings, machine parts, electronic circuits, and other structures. A CAD drawing may communicate technical details, such as dimensional information and material specifications, that can be used as a guide in making or manufacturing what is represented in the drawing.

A number of different CAD packages are available in the marketplace. A CAD package includes CAD software and sometimes proprietary hardware such as specialized input peripherals designed for use with the accompanying software. Some CAD packages are specific to or optimized for two-dimensional (2D) drawings, which may be preferably for drawing building floor plans and electrical circuits, for example. Other CAD packages are specific to, or optimized for, three-dimensional (3D) drawings, alternatively referred to as solid modeling.

Using the capabilities of modern computer systems, CAD enables the creation of large and technically complex drawings. A drawing that is too large to be displayed on a screen in its entirety may be separated into multiple pages, and the multiple pages may be selectively displayed. This separation of a drawing into multiple pages is commonly done, for example, in circuit designs, due to the very large number of elements that may be present in an electronic circuit. By separating the drawing into pages, however, components that are connected within a particular design may be located on different pages of the drawing. A computer system running CAD has plenty of capacity to handle drawings separated into many pages. However, it is challenging to communicate the large amount of graphical detail contained within such a drawing in a manner that allows a user to effectively visualize the drawing.

### BRIEF SUMMARY

This disclosure includes a method of computer-aided design. In an example method, nets in an electronic drawing are identified, wherein each net represents a connection between two or more drawing elements located on separate pages of the electronic drawing. A connection preview is generated for each net, where each connection preview includes a calculated image of the two or more drawing elements connected by the net. The generated connection previews are stored in a preview database. User-selected pages from the electronic drawing are displayed along with a net reference uniquely associated with each net present on the pages. In response to a user-selection of one of the net references, the previously-generated connection preview for the associated net are obtained from the preview database and displayed. The method may be performed by a computer system executing computer usable program code for performing the described method steps.

### BRIEF DESCRIPTION OF THE SEVERAL VIEWS OF THE DRAWINGS

FIG. 1 is a schematic diagram of a hypothetical page view pane and preview pane generated by an exemplary computer-aided design (“CAD”) package.

FIG. 2 is a schematic diagram of a dynamic workspace displayed on the viewable area of the display device.

FIG. 3 is a schematic diagram of the previews database illustrating four possible connection previews for Foo_net_n.

FIG. 4 is a flowchart outlining an example of a computer-implemented method of analyzing and processing an electronic drawing to facilitate subsequent visualization of the electronic drawing.

### DETAILED DESCRIPTION

A CAD package and related software and methods are disclosed that provide effective visualization of connected drawing elements located on different pages of an electronic drawing. In a disclosed example of a method, nets are used to represent the various connections between elements. According to the method, previews for these connections between drawing elements are automatically generated. For example, the connection previews may be automatically generated as the nets are created. Alternatively, an inventory of the electronic drawing may be taken, wherein all of the existing nets are identified and all of the connection previews associated with the identified nets are automatically generated. Such an inventory may be performed at times when the user is not actively editing the drawing, such as when the drawing is loaded, when the drawing is saved, or at predetermined intervals.

The connection previews each include a calculated image of elements connected by the respective net. The connection previews may also include positional information describing the relative position of the connected elements within the complete electronic drawing. The nets and connection previews are separate entities, with each net defining a connection between two or more drawing elements and each connection preview including a pre-calculated image of the elements as connected by a particular net. The automatically-generated connection previews are stored in memory, such as in a preview database, for subsequent recall and display in response to user input requesting to view the connection preview. It is also possible for the connection previews to be generated in response to selecting a particular net.

The connection previews are made available to a user when the user is working with the electronic drawing. In working with the electronic drawing, the user may select desired pages from the drawing. The selected pages may be displayed in one or more page view pane of a display device. Each page may include labels, as references for any nets contained within that page. To preview a connection, the user may select a net reference, such as by positioning or clicking a cursor in close proximity to the net reference. In response to this user selection of the net reference, a connection preview is displayed in a preview pane of the display device. For example, any connection previews already calculated and stored in a preview database for that net may be automatically recalled and displayed. The preview pane may be a pop-up window, for example. The user has the option to then select the displayed preview to be added to a dynamic workspace, such as by clicking on the connection preview using the pointing device. Elements and connections added to the dynamic workspace are fully editable from the dynamic workspace. Any changes made in the dynamic workspace are updated to the pages containing the changed elements.

According to the disclosed systems and methods, the preview function and dynamic workspace are especially efficient in terms of system resources, such as CPU cycles and system memory. When the user subsequently works with the drawing, the connection previews have already been calculated for prompt recall and display. Displaying a connection preview that has already been calculated and stored in advance is therefore faster and more efficient than it would be to generate the connection preview “live” while the user is working with the drawing.

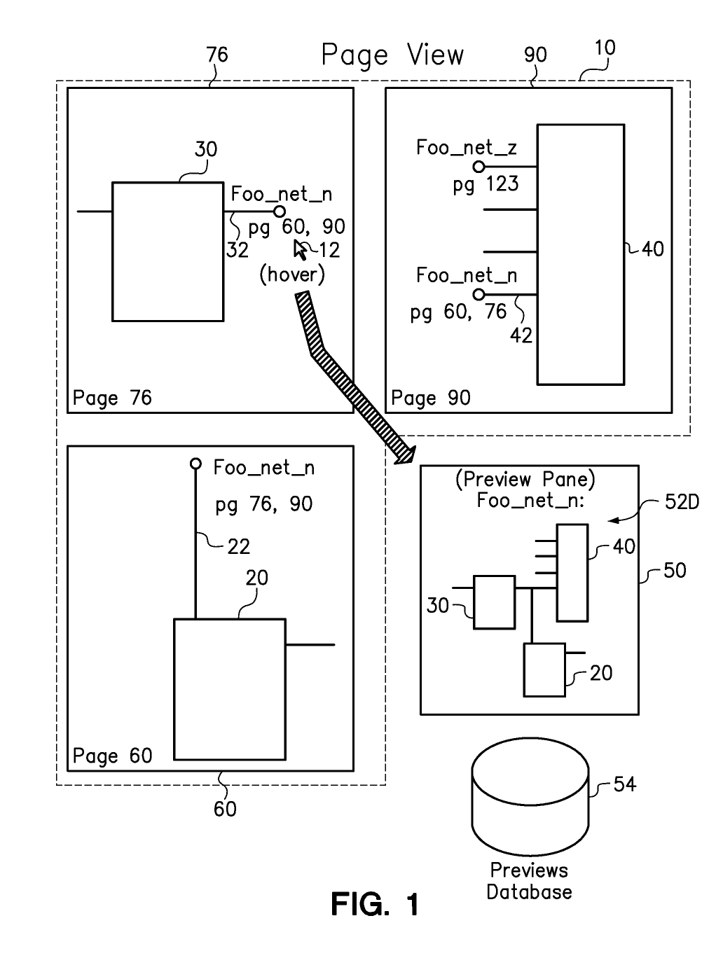

FIG. 1 is a schematic diagram of a hypothetical page view pane 10 and preview pane 50 generated as visual output by an exemplary computer-aided design (“CAD”) package. The CAD package may be implemented as software residing on a computer system, such as a personal computer (PC), a user terminal connected to a workstation blade, or a user terminal connected to a cloud computing environment. The CAD package may include software instructions in the form of computer usable program code embodied on a non-transitory storage medium, such as a hard disk drive providing non-volatile storage. The software instructions may be selectively loaded on an as-needed basis into another non-transitory storage medium, such as system memory providing volatile storage, for execution by a processor, e.g. central processing unit (CPU). Peripheral input/output devices of the computer system may include a mouse and keyboard, allowing a user to interface with the CAD package to create and edit electronic drawings. The computer system also includes a display device, such as one or more liquid crystal display (LCD) panel or cathode ray tube (CRT). The page view environment 10 and preview pane 50 may be simultaneously displayed on the display device in different regions of the display area. Hardware elements such as display devices and input peripherals are generally known in the art, apart from any inventive aspects of their use described herein, and are therefore omitted from FIG. 1 for clarity.

An electronic drawing may be created and edited by a user who interfaces with the CAD package. An electronic drawing file is used to store an electronic representation of the drawing, which may be created and edited from within system memory, and stored indefinitely in non-volatile storage. The electronic drawing contains user-selected drawing elements, user-specified interconnections between the drawing elements, and positional and/or dimensional information about the drawing elements. For example, a drawing may be constructed from drawing elements such as relatively simple segments, arcs, geometric shapes, and lines or shapes drawn “free-hand” with a pointing device. More complex drawing elements may also be available from a menu, such as pre-defined representations of circuit board elements stored in the CAD package. The CAD package may generate a visual output on the display device representing the electronic drawing file (or portions thereof), including the drawing elements as calculated according to their specified interconnections and positional information. In FIG. 1, the visual output includes the page view environment 10 and the preview pane 50.

Very large drawings may be created using the CAD package. The size of the electronic drawing file may be limited only by system resources, such as by the amount of system memory available for retaining the electronic drawing file and the software instructions of the CAD package. For many applications, such as complex circuit designs, an electronic drawing may be prepared that is too large to be displayed in its entirety on the display device with a visually discernable level of detail. Therefore, the electronic drawing file may be separated electronically into pages that are sized for displaying at a scale sufficient to allow a user to view the details of the displayed page. The drawing files may be separated into many pages, such as hundreds of pages. The specific pages to be displayed at any one time may be selected by the user. FIG. 1 shows three example pages 60, 76, 90.

The scale and position of the pages may be adjusted so that several pages may be simultaneously shown on the display device. The user interface of the CAD package may include zoom and pan features, such as to zoom in/out and pan left/right and up/down. At the current level of zoom in FIG. 1, all three pages 60, 76, 90 and the preview pane 50 are simultaneously displayed on a viewable area of the display device. Depending on the current level of zoom, the pages currently selected for display may or may not fit within the viewable area of the display device. For example, a user may zoom in to enlarge certain details of the displayed pages, causing some portion of the pages 60, 76, 90 to extend outside the viewable area of the display device, and require panning (e.g. left/right and/or up/down) to fully view the selected pages. Conversely, zooming out or panning may bring into view other selected pages that are not currently visible in FIG. 1.

The CAD package may generate various display output on the display device relating to the electronic drawing. The display output includes, by way of example, the page view environment 10 and the preview pane 50. Each of pages 60, 76, and 90 in the page view environment 10 includes a different set of drawing elements from different locations within the electronic drawing. The drawing elements are shown in schematic form as rectangles, including drawing elements 20, 30, 40 on each of the pages 60, 76, 90, respectively. The different drawing elements 20, 30, 40 may be elements from anywhere in the electronic drawing, with different levels of detail and complexity, and their schematic representation as rectangles is not intended to convey actual shape details. For example, each drawing element 20, 30, 40 may actually represent a different circuit, wherein each circuit is connected at the location of an automatically-generated net named Foo_net_n.

Such nets may be used throughout the electronic drawing to identify connections between elements located on different pages. Each net may have a uniquely associated net reference. For example, the net having net reference “Foo_net_n” is illustrated schematically as the intersection between line segments 22, 32, 42 extending from the rectangles used to represent the drawing elements 20, 30, 40. Another example net in FIG. 1 is “Foo_net_z.” Other nets may also exist within the pages 60, 76, 90, but are omitted from view in FIG. 1. Page numbers below the net references refer to the other pages linked by the nets. Foo_net_n connects element 20 of page 60 with element 30 of page 76 and element 40 of page 90. Thus, in page 60, the net reference Foo_net_n references pages 76 and 90; in page 76, Foo_net_n references pages 60 and 90; and in page 90, Foo_net_n references pages 60 and 76.

The CAD package allows a user to preview drawing elements as interconnected by a selected net. These connection previews may have been previously generated for the existing nets contained within the drawing. The user may select a net using a peripheral input device, such as by maneuvering a pointing device to position a cursor 12 in proximity to the net reference associated with the net. In FIG. 1, this selection of a net is illustrated as being performed by hovering the cursor 12 over (or in proximity to) Foo_net_n within the page 76 of the electronic drawing. In response to this selection of Foo_net_n, the CAD package displays a previously stored connection preview 52D of elements 20, 30, 40 as interconnected by Foo_net_n in the preview pane 50. The connection preview 52D in this example shows all three elements 20, 30, 40 interconnected by Foo_net_n. However, as discussed further below, the preview pane 50 may alternatively be used to display just a subset (i.e. any two) of the elements 20, 30, 40 interconnected by Foo_net_n. This selection of elements to include in the connection preview 52D may be indicated according to a particular maneuvering of a peripheral input device. For example, positioning the cursor 12 between the “60” and the “90” in page 76, as shown, may select a pre-calculated connection preview 52D that shows all three elements 20, 30, 40 connected. Alternatively, moving the cursor 12 closer to the “60” in page 76 may display a preview of the connection between two elements 20 and 30 at Foo_net_n, or moving the cursor 12 closer to the “90” in page 76 may display a preview of the connection between two elements 20, 40 at Foo_net_n.

Each of the possible connection previews for each net in the electronic drawing are preferably pre-calculated and stored in memory, in a previews database 54. The connection preview(s) for a particular net may be automatically generated in response to the creation of that net. Alternatively, a complete set of connection previews may be determined by inventorying the electronic drawing file. The inventorying may be performed automatically, such as in response to opening the CAD package, in response to opening the drawing file within the CAD package, in response to saving or closing the drawing file, or at predefined intervals. Generating each connection preview may entail, for example, making positional calculations to determine the relative placement and orientation of each drawing element connected by a net, and rendering an electronic image representative of the connected drawing elements.

This process of calculating a connection preview consumes memory and CPU resources. Desirably, calculating all possible connection previews and storing the connection previews in the previews database 54 in advance of the user working with the drawing avoids the need to generate connection previews live, i.e. “on-the-fly,” while the user is working with the CAD package. This liberates system resources such as processor cycles and system memory, which may be needed for other tasks involved in the user working with the CAD package. Previously calculated connection previews may be recalled from the previews database 54 faster and more efficiently than generating the connection previews live. By performing all of the calculations necessary for generating connection previews in advance, the image previews may be promptly recalled and displayed, with less lag time between the selection of a net and the display of the associated connection preview. This allows the user to navigate and visualize desired portions of an electronic drawing quickly and efficiently. The user may obverse different pages in the page view environment 10, quickly recalling and displaying previously-stored connection previews with simple gestures on a pointing device or other input peripheral.

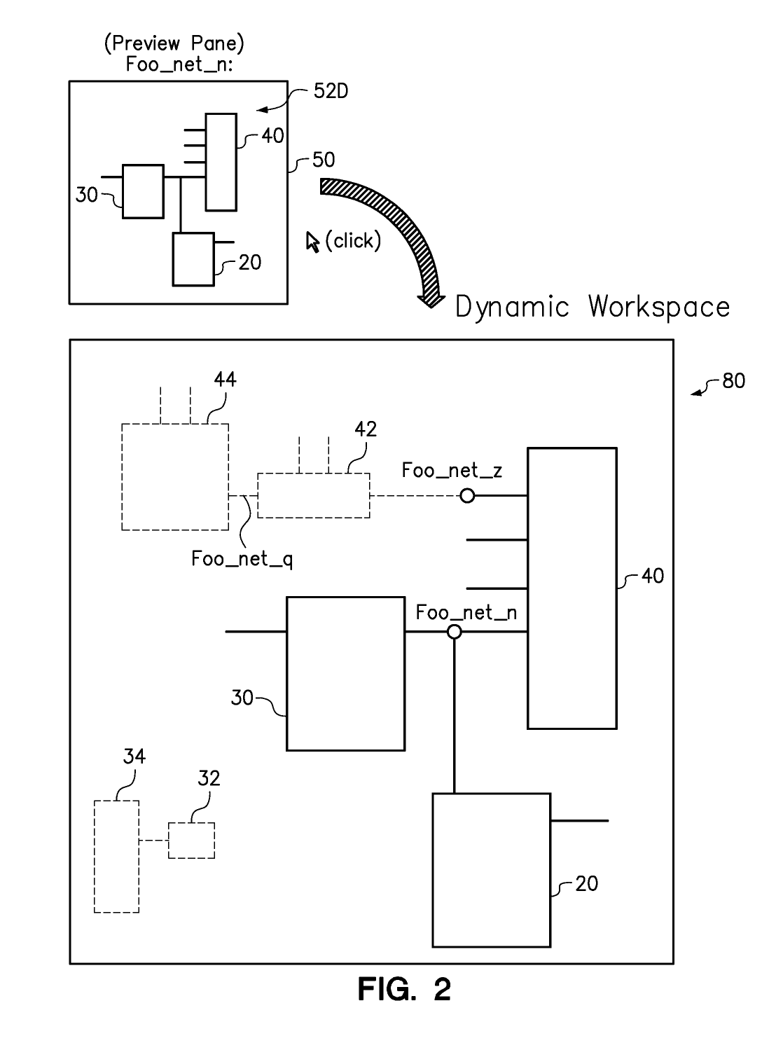

FIG. 2 is a schematic diagram of a dynamic workspace 80 displayed on the viewable area of the display device. The dynamic workspace 80 may be displayed simultaneously with, and operate in tandem with, the hypothetical page view environment 10 and preview pane 50 of FIG. 1. The dynamic workspace 80 displays any user-selected portion of the electronic drawing, and is fully editable. The individual pages (see FIG. 1) are also individually editable. However, the dynamic workspace 80 eliminates the need for a user to switch back and forth between pages, by selecting only the pages/elements of the electronic drawing that the user chooses to view and edit. Previews generated in the preview pane 50 may be added to the dynamic workspace 80 in response to user input from a peripheral device, such as with the click of a mouse. For example, FIG. 2 illustrates the step of adding the connection preview 52D for Foo_net_n to the dynamic workspace. Thus, a pointing device may be used to first display a previously-stored connection preview 52D for Foo_net_n by hovering the cursor 12 over the net reference, as shown in FIG. 1. Then, the elements 20, 30, 40 as connected by Foo_net_n may be added to the dynamic workspace 80 by clicking on the connection preview 52D. Other elements may be similarly added to the dynamic workspace 80 by selecting other nets from the various pages in the page view environment.

Elements added to the dynamic workspace 80 may be positioned relative to any other elements previously added to the dynamic workspace 80. If the newly added elements have any connection with a previously added element, then the newly added elements may be positioned and connected to the previously added elements. For example, additional elements 42, 44 may be added to the dynamic workspace 80, either before or after the group of elements 20, 30, 40 have been added, by displaying and selecting a preview for the net “Foo_net_q.” Element 42 is shown to have a connection with element 40 at “Foo_net_z.” Thus, when elements 40, 42 are both present in the dynamic workspace 80, elements 40 and 42 may be positioned within the dynamic workspace 80 with the connection at Foo_net_z. As another example, additional elements 32, 34 have been added at some point. No direct connection currently exists between these additional elements 32, 34 and any of the other elements currently shown in the dynamic workspace 80. Thus, the additional elements 32, 34 may be positioned with the proper relative positioning to the other elements 20, 30, 40, 42, 44, but with no connection to these other elements.

If a redundant element is ever added to the dynamic workspace as a result of having selected two different nets with at least one element in common, the CAD package may identify the redundant element(s), and track and display only one instance of that element. For example, if Foo_net_n (connecting elements 20, 30, 40) had been added to the dynamic workspace 80 and Foo_net_z (connecting elements 40 and 42) is subsequently added to the dynamic workspace 80, then element 40 would be redundant. Thus, only one instance of element 40 would be placed in the dynamic workspace 80. This avoids the software having to keep track of multiple identical graphics objects in the same position within the dynamic workspace 80.

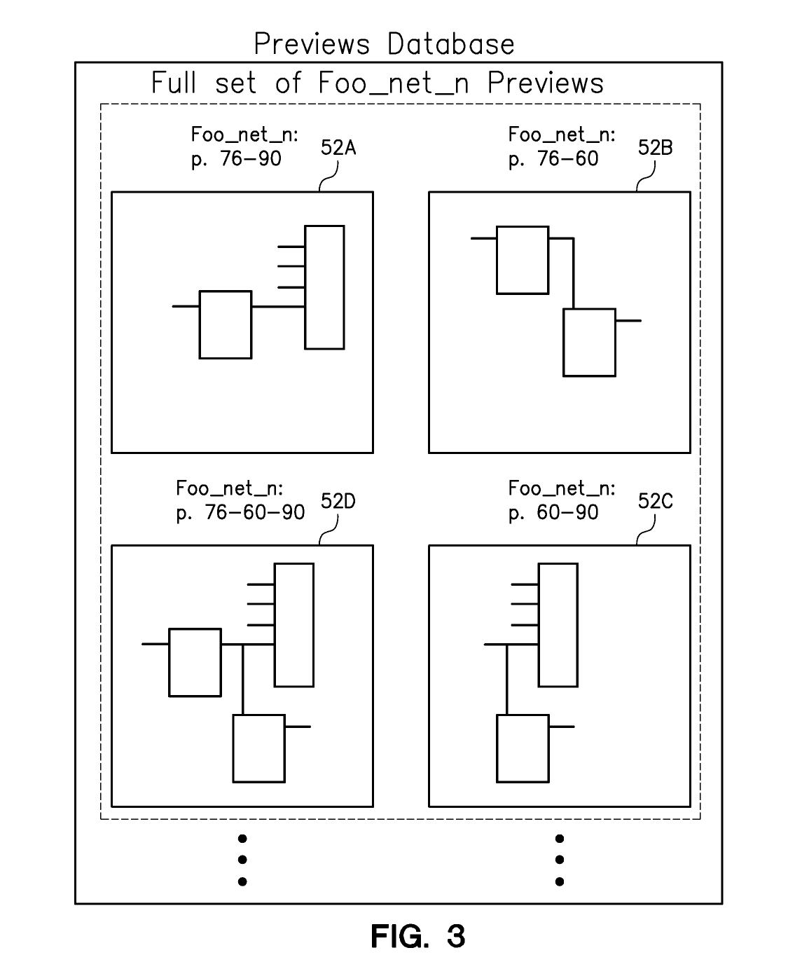

FIG. 3 is a schematic diagram of the previews database 54 illustrating four possible connection previews for Foo_net_n. The previews database 54 may contain many other connection previews for other nets, although only the Foo_net_n previews are shown by example in FIG. 3. As noted above, a net may connect two or more drawing elements. A user may desire to see a connection preview for only a subset of the elements connected by a particular net, wherein the subset contains fewer than all of the elements connected by that net. In this example, four separate connection previews 52A, 52B, 52C, 52D have been generated for Foo_net_n. Connection preview 52A shows elements 30 and 40, connection preview 52B shows elements 20 and 30, connection preview 52C shows elements 20 and 40, and connection preview 52D shows all three elements 20, 30, and 40. The user may select which of these available connection previews 52A-D to be displayed in response to selecting a net.

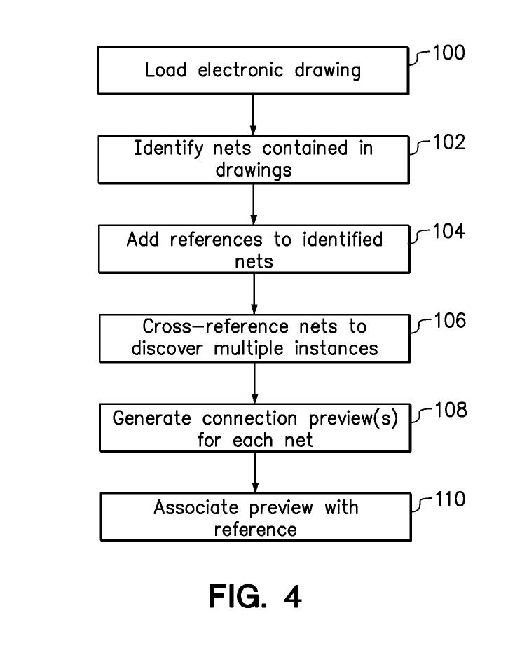

FIG. 4 is a flowchart outlining an example of a computer-implemented method of analyzing and processing an electronic drawing to facilitate subsequent visualization of the electronic drawing. In step 100, the drawing is loaded into system memory. In step 102, the drawing is analyzed to identify nets connecting elements contained within the drawing. A unique reference may be automatically created in step 104. Each reference may include a unique label associated with the respective net, such as Foo_net_n. The references may be generated manually by a user, periodically at prescribed intervals, or in response to an action such as saving the electronic drawing file to system memory. In step 106, the identified nets are cross-referenced to determine page locations of multiple instances of a particular reference. The pages numbers at which a particular net is located may also be added to the reference generated in step 104. For example, in FIG. 1, each instance of Foo_net_n in a particular page included a list of the other page numbers at which that net was also located. In step 108, one or more connection preview is generated for each net. As was demonstrated by example in FIG. 3, multiple previews may be generated for a particular net, where each preview contains a different subset of the elements connected by the particular net. In step 110, the preview generated in step 108 is associated with the reference generated in step 104, so that the preview may be subsequently recalled from memory and displayed in response to selection of the reference.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of computer-aided design, comprising:
identifying nets in an electronic drawing, wherein each net represents a connection between two or more drawing elements located on separate pages of the electronic drawing;
generating a connection preview for each net, each connection preview including a calculated image of the two or more drawing elements connected by the net, and storing each generated connection preview in a preview database;
displaying user-selected pages from the electronic drawing along with a net reference uniquely associated with each net present on the page; and
in response to a user-selection of one of the net references, obtaining the previously-generated connection preview for the associated net from the preview database and displaying the connection preview.

2. The method of claim 1, wherein the step of identifying nets in the electronic drawing comprises:
inventorying the electronic drawing to identify all of the nets currently in the electronic drawing.

3. The method of claim 2, further comprising:
performing the step of inventorying the electronic drawing automatically in response to one or more of loading the electronic drawing into system memory or saving the electronic drawing.

4. The method of claim 2, further comprising:
performing the step of inventorying the electronic drawing automatically at predefined intervals.

5. The method of claim 2, further comprising:
completing the step of inventorying the electronic drawing before allowing the step of displaying selected pages from the electronic drawing.

6. The method of claim 1, further comprising:
for each identified net, generating a net reference uniquely associated with that net.

7. The method of claim 1, further comprising:
in response to a user-selection of the displayed connection preview, adding the two or more drawing elements connected by the associated net, in an editable form, to a dynamic workspace.

8. The method of claim 7, further comprising:
editing the drawing elements in the dynamic workspace in response to user input; and
updating the drawing elements in the pages of the electronic drawing in response to the editing.

9. The method of claim 1, further comprising:
generating and storing the connection previews for each net in response to creation of that net.

10. The method of claim 1, further comprising:
generating a plurality of different previews for a particular net, each preview containing a different subset of the elements connected by the particular net.

11. A computer program product including computer usable program code embodied on a computer usable storage medium, the computer program product comprising:
computer usable program code for identifying nets in an electronic drawing, wherein each net represents a connection between two or more drawing elements located on separate pages of the electronic drawing;
computer usable program code for generating a connection preview for each net, each connection preview including a calculated image of the two or more drawing elements connected by the net, and storing the generated connection previews in a preview database;
computer usable program code for displaying user-selected pages from the electronic drawing along with a net reference uniquely associated with each net present on the page; and
computer usable program code for in response to a user-selection of one of the net references, obtaining the previously-generated connection preview for the associated net from the preview database and displaying the connection preview.

12. The computer program product of claim 11, wherein the computer usable program code for identifying nets in the electronic drawing comprises:
computer usable program code for inventorying the electronic drawing to identify all of the nets currently in the electronic drawing.

13. The computer program product of claim 12, further comprising:
computer usable program code for inventorying the electronic drawing automatically in response to one or more of loading the electronic drawing into system memory or saving the electronic drawing.

14. The computer program product of claim 12, further comprising:
computer usable program code for inventorying the electronic drawing automatically at predefined intervals.

15. The computer program product of claim 12, further comprising:
computer usable program code for completing the step of inventorying the electronic drawing before displaying selected pages from the electronic drawing.

16. The computer program product of claim 11, further comprising:
computer usable program code for generating a net reference uniquely associated with each identified net.

17. The computer program product of claim 11, further comprising:
computer usable program code for, in response to a user-selection of the displayed connection preview, adding the two or more drawing elements connected by the associated net, in an editable form, to a dynamic workspace.

18. The computer program product of claim 17, further comprising:
computer usable program code for editing the drawing elements in the dynamic workspace in response to user input; and
computer usable program code for updating the drawing elements in the pages of the electronic drawing in response to the editing.

19. The computer program product of claim 11, further comprising:
computer usable program code for generating and storing the connection previews for each net in response to creation of that net.

20. The computer program product of claim 11, further comprising:
computer usable program code for generating a plurality of different previews for a particular net, each preview containing a different subset of the elements connected by the particular net.
